(19) United States
(12) Patent Application Publication
(10) Pub. No.: US 2026/0184071 A1
(43) Pub. Date: Jul. 2, 2026

(54) A DROPLET EJECTION HEAD AND METHOD OF OPERATION

(71) Applicant: XAAR TECHNOLOGY LIMITED, Huntingdon, Cambridgeshire (GB)

(72) Inventors: Justin NOBLE, Huntingdon, Cambridgeshire (GB); Neil DARRACOTT, Huntingdon, Cambridgeshire (GB); Artur JEDYNAK, Huntingdon, Cambridgeshire (GB)

(21) Appl. No.: 19/129,347

(22) PCT Filed: Nov. 14, 2023
(86) PCT No.: PCT/GB2023/052975

§ 371 Date: May 13, 2025

(30) Foreign Application Priority Data
Nov. 14, 2022 (GB) 2216945.2

(51) Int. Cl. B41J 2/14

(52) U.S. Cl. CPC B41J 2/1408; B41J 2/14072

(57) ABSTRACT

A droplet ejection head includes one or more actuator components, an inlet path to supply fluid to and an outlet path to remove fluid from the actuator components. The actuator components include fluid chambers, each having at least one nozzle and being actuable to eject one or more droplets via the nozzle. The fluid chambers are connected to the inlet path and to the outlet path. The outlet path includes one or more heat exchangers downstream of the actuator components and one or more actuator drive electronic components adjacent to each heat exchanger. The heat exchangers include one or more heat exchanger fluid paths. In use heat transfers from the actuator drive electronic components to the heat exchangers and is removed via the return fluid. An area demarcated by the actuator drive electronic components is substantially contained within an area in the same plane demarcated by the heat exchanger fluid paths.

The present disclosure relates to a droplet ejection head. The droplet ejection head may be a drop-on-demand inkjet printhead. The droplet ejection head may comprise one or more actuator components and a supply path to supply fluid to the one or more actuator components and a return path to remove fluid from the one or more actuator components. The actuator component may comprise actuators being operable to cause the release, in an ejection direction, of liquid droplets through nozzles in response to electrical signals provided by actuator drive electronic components. In applications that require high ejection frequency and/or high ejection duty, the actuator drive electronic components may produce high amounts of heat, to a level that may prove detrimental to the reliability and/or lifetime of the droplet ejection head. The present disclosure relates to a droplet ejection head with improved heat management capability.

### BACKGROUND

Droplet ejection heads are now in widespread usage, whether in more traditional applications, such as inkjet printing, or in 3D printing, or other rapid prototyping techniques. Droplet ejection heads have been developed that are capable of use in industrial applications, for example for printing directly onto substrates, such as ceramic tiles or textiles, or to form elements, such as colour filters in LCD or OLED displays for flat-screen televisions. Such industrial printing techniques using droplet ejection heads allow for short production runs, customization of products and even printing of bespoke designs. It will therefore be appreciated that droplet ejection heads continue to evolve and specialise so as to be suitable for new and/or increasingly challenging applications. However, while a great many developments have been made in the field of droplet ejection heads, there remains room for improvements.

In recent years, there has been increasing interest in operating at increasingly high frequencies so as, for example, to increase print speeds. Increasing the operating frequency tends to increase the amount of heat generated in the actuator drive electronic components, which can lead to undesirably elevated temperatures therein. This effect is exacerbated when operating at high or maximum ejection duties (i.e., from a majority up to all of the droplet ejection nozzles ejecting droplets, at the same time). There is, therefore, increasing interest in thermal management of the actuator drive electronic components at these operating conditions. Lowering the actuator drive electronic components temperature will improve the operating temperature, increase product life, increase reliability, and improve drop uniformity as a result of reduced thermal stress in the actuator component, for example by enabling the fluid viscosity to be maintained within a narrower operating window. Still further, removing a significant proportion of the heat generated by the actuator drive electronic components may reduce thermally induced structural variation in the droplet ejection head, which may improve the print performance, by limiting variation in the aligned position and shape and size of the droplet ejection head, and limiting or eliminating alignment variation between a given droplet ejection head and other components (such as other droplet ejection heads) in a droplet ejection apparatus.

The present invention has been devised in view of the aforementioned problem.

### SUMMARY OF THE INVENTION

Aspects of the invention are set out in the appended independent claims, while details of particular embodiments of the invention are set out in the appended dependent claims.

According to a first aspect of the invention there is provided a droplet ejection head comprising one or more actuator components and an inlet path to supply fluid to the one or more actuator components and an outlet path to remove fluid from the one or more actuator components;
wherein said one or more actuator components comprise a plurality of fluid chambers; wherein said fluid chambers comprise at least one nozzle; and wherein said fluid chambers are actuable to eject one or more droplets via said at least one nozzle in response to ejection instructions;
wherein said plurality of fluid chambers are fluidically connected at a respective first end to said inlet path and are fluidically connected at a respective second end to said outlet path;
wherein said outlet path comprises one or more heat exchangers arranged serially downstream of the one or more actuator components;
wherein one or more actuator drive electronic components are arranged adjacent to each of said heat exchangers;
wherein the one or more heat exchangers comprises one or more heat exchanger fluid paths, such that in use heat transfers from said actuator drive electronic components to said one or more heat exchangers and is removed via the return fluid; and
wherein an area demarcated by the actuator drive electronic components is substantially contained within an area in the same plane demarcated by said one or more heat exchanger fluid paths.

According to a second aspect of the invention there is provided a droplet ejection apparatus comprising one or more droplet ejection heads according to the first aspect of the invention, and a source of droplet ejection fluid fluidically connected to said one or more droplet ejection heads via a fluid inlet path so as to supply fluid to said one or more droplet ejection heads and a fluid return path to remove fluid from said one or more droplet ejection heads.

According to a third aspect of the invention there is provided a method of cooling one or more actuator drive electronic components for a droplet ejection head according to the first aspect of the invention, wherein said method comprises, in turn:
supplying fluid to said one or more actuator components via said inlet path; and
removing fluid from said one or more actuator components via said outlet path and introducing fluid into the heat exchanger fluid path such that it flows through the one or more heat exchangers and removes heat transferred to said heat exchanger from said actuator drive electronic components via the fluid flowing through the one or more heat exchangers.

According to a fourth aspect of the invention, there is provided a method of operating a droplet ejection apparatus according to the second aspect of the invention, wherein said method comprises, in turn:
supplying fluid to said one or more droplet ejection heads via said fluid inlet path;
supplying fluid to said one or more actuator components via said inlet path;
ejecting a proportion of said fluid from one or more nozzles in said actuator component in response to ejection instructions;
removing the unejected fluid from said one or more actuator components via said outlet path;
transferring thermal energy from said one or more actuator drive electronic components to said heat exchanger; and
removing some or all of said thermal energy from said heat exchanger by
transferring thermal energy to said unejected fluid in said outlet path; and
removing said unejected fluid from said one or more droplet ejection heads via said fluid return path.

According to a fifth aspect of the invention, there is provided a method of operating a droplet ejection apparatus according to the second aspect of the invention, to heat the fluid in one or more droplet ejection heads according to a first aspect of the invention, wherein said method comprises, in turn:
supplying fluid to the one or more droplet ejection apparatus via the fluid return path;
using a suitable waveform or function to generate heat in the one or more actuator drive electronic components;
transferring thermal energy from the one more actuator drive electronic components to the heat exchanger;
transferring some or all of the thermal energy from the heat exchanger to the fluid in the heat exchanger fluid path;
supplying fluid from the heat exchanger to the one or more actuator components; and
removing fluid from the one or more actuator components via the inlet path.

### BRIEF DESCRIPTION OF THE DRAWINGS

FIG. 1A depicts an apparatus for droplet ejection comprising a fluid supply, a fluid path comprising a fluid inlet path and a fluid return path, and a droplet ejection head according to an embodiment comprising a heat exchanger arranged adjacent to the actuator drive electronic components.

FIG. 1B depicts an end view of the droplet ejection head of FIG. 1A.

FIG. 1C depicts a cross-section of the droplet ejection head of FIG. 1A and FIG. 1B, as indicated in FIG. 1B, showing that the heat exchanger comprises a return loop in the heat exchanger fluid path where the straight legs of the return loop are separated by a peninsula wall aligned with the array direction.

FIG. 2A depicts an apparatus for droplet ejection, similar to that of FIG. 1A, and comprising a droplet ejection head according to another embodiment comprising a heat exchanger, the heat exchanger comprising protrusions with heat exchange interface surface(s) adjacent to the actuator drive electronic components and further that the heat exchanger fluid path comprises a plurality of fluid paths separated by walls as seen in FIG. 2C.

FIG. 2B depicts an end view of the droplet ejection head of FIG. 2A.

FIG. 2C depicts a cross-section BB, of the droplet ejection head of FIG. 2A and FIG. 2B, as indicated in FIG. 2B, showing that the heat exchanger fluid path comprises a plurality of paths separated by walls where the walls are aligned with the array direction in the heat exchanger fluid path.

FIG. 2D depicts a cross-section CC of the heat exchanger of FIG. 2A-2C, as indicated in FIG. 2C, showing the horizontal walls in the heat exchanger fluid path.

FIG. 3A depicts an end view of another embodiment of a heat exchanger similar to that of FIG. 2D.

FIG. 3B depicts a cross-section DD of the embodiment of a FIG. 3A, indicated in FIG. 3A, where the walls in the heat exchanger fluid path have been replaced with ridges which leave an opening or gap in the fluid path space in the centre of the heat exchanger.

FIG. 3C depicts a cross-section EE of the embodiment of a FIG. 3A and FIG. 3B, indicated in FIG. 3B, showing the ridges from an alternative view.

FIG. 4A depicts an end view of a heat exchanger suitable for use in an alternative embodiment comprising a plurality of pillars in the heat exchanger fluid path.

FIG. 4B depicts a cross-section FF of the embodiment of a FIG. 4A, indicated in FIG. 4A, showing a plurality of pillars in the heat exchanger fluid path.

FIG. 5A depicts an end view of a heat exchanger suitable for use in an alternative embodiment comprising a serpentine fluid path.

FIG. 5B depicts a cross-section GG of the embodiment of FIG. 5A, indicated in FIG. 5A, showing a serpentine path comprising a plurality of return loops in the heat exchanger fluid path separated by peninsula walls where the peninsula walls and the straight legs of the return loops are aligned with the ejection direction.

FIG. 6A depicts an end view of a heat exchanger suitable for use in an alternative embodiment comprising a heat exchanger fluid path with a serpentine path, similar to that of FIG. 5B, and where the protrusion heat exchange interface surfaces are at an angle to the ejection direction and spigots for fluidic connection are located at the inlet and outlet to the heat exchanger.

FIG. 6B depicts a cross-section HH of the embodiment of FIG. 6A, indicated in FIG. 6A, showing the fluid path with a serpentine shape with return loops with rounded corners and straight legs aligned with and parallel to the ejection direction and further comprising a loop, prior to the heat exchanger outlet, with a straight leg perpendicular to the ejection direction and the spigots for fluidic connection.

FIG. 6C depicts a detail C of the cross-section HH of FIG. 6B, indicated in FIG. 6B, showing a spigot arranged to connect the outlet path, specifically the first part of the outlet path, to the heat exchanger inlet.

FIG. 6D depicts a side view of the heat exchanger and spigots of FIG. 6A-Fig. 6C and further depicts a part of the outlet path and a fluid diverter to connect to the actuator component.

FIG. 6E depicts the fluid diverter of FIG. 6D.

FIG. 6F depicts the underside of the fluid diverter of FIG. 6E and FIG. 6D.

FIG. 7A depicts an end view of a PCB (printed circuit board) suitable for use in embodiments of the invention.

FIG. 7B depicts a cross-section II of the PCB of FIG. 7A, indicated in FIG. 7A, showing the internal structure.

FIG. 7C depicts the end view of a PCB of FIG. 7A, with an actuator drive electronic component arranged adjacent to and attached to the second thermally conductive region.

FIG. 7D depicts the actuator drive electronic component of FIG. 7C viewed from the interface side (i.e., viewing the face that is adjacent to the second thermally conductive region) showing that the actuator drive electronic component comprises a plurality of actuator drive electronics components.

FIG. 8A depicts a droplet ejection head according to another embodiment comprising a PCB similar to that of FIG. 7A and FIG. 7B and a thermally conductive adhesive layer between the protrusion heat exchange interface surface(s) on the heat exchanger and the first thermally conductive regions of the respective PCBs. The second thermally conductive regions of the respective PCBs are arranged adjacent to the actuator drive electronic components.

FIG. 8B depicts an end view of the droplet ejection head of FIG. 8A indicating the presence of an air gap between the PCB and the heat exchanger except in the region of the protrusion.

FIG. 9 depicts a droplet ejection head according to another embodiment comprising two actuator components, a nozzle plate, and further comprising two heat exchangers arranged adjacent to the actuator drive electronic components each heat exchanger arranged in series with a respective actuator component.

FIG. 10A depicts an end view of a heat exchanger suitable for use in an alternative embodiment comprising a heat exchanger fluid path with a serpentine shape, similar to that of FIG. 6B, where the heat exchanger fluid path additionally comprises a sleeve.

FIG. 10B depicts a cross-section JJ of the embodiment of FIG. 10A, indicated in FIG. 10A, showing the heat exchanger fluid path and the sleeve.

FIG. 11A depicts an end view of a heat exchanger suitable for use in an alternative embodiment comprising a heat exchanger fluid path with a serpentine shape, similar to that of FIGS. 10A and 10B, where the heat exchanger fluid path additionally comprises a sleeve and an interface material.

FIG. 11B depicts a cross-section KK of the embodiment of FIG. 11A, indicated in FIG. 11A, showing the heat exchanger fluid path, the sleeve and the interface material.

It should be noted that the drawings are not to scale and that certain features may be shown with exaggerated sizes so that these are more clearly visible.

### DETAILED DESCRIPTION OF THE DRAWINGS

Embodiments of the invention and their various implementations will now be described with reference to the drawings. Throughout the following description, like reference numerals are used for like elements where appropriate.

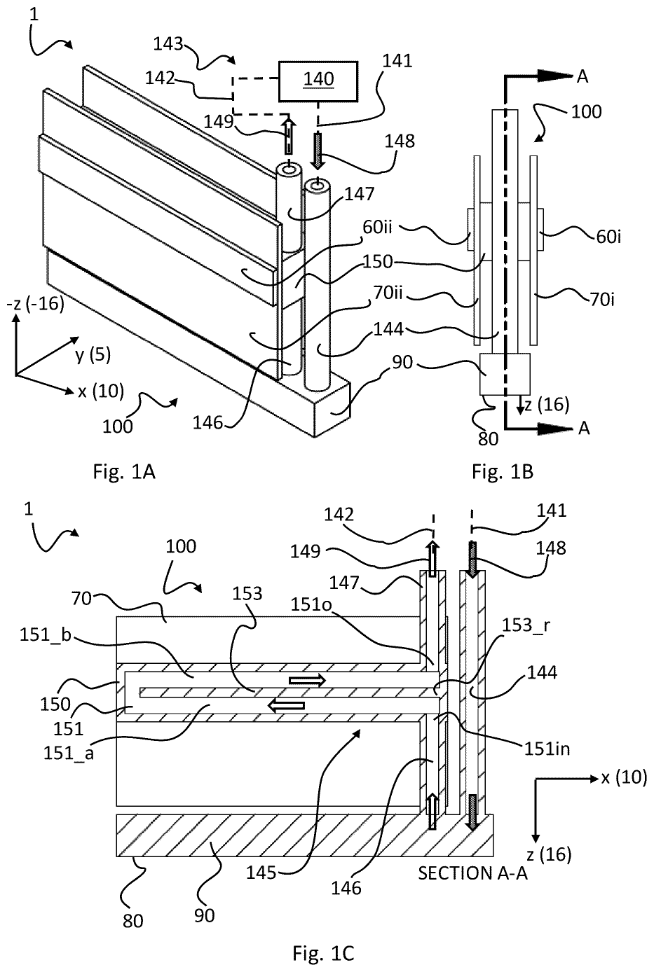

FIG. 1A depicts an apparatus 1 for droplet ejection comprising a fluid supply 140, a fluid path 143, comprising a fluid inlet path 141 and a fluid return path 142, and a droplet ejection head 100 according to an embodiment. The droplet ejection head 100 comprises a heat exchanger 150 arranged adjacent to the actuator drive electronic components 60. It can be seen that there are two sets of actuator drive electronic components 60i, 60ii each mounted on a respective PCB 70i, 70ii and located adjacent to the heat exchanger 150, one on either side (i.e., the respective PCBs 70i, 70ii are interposed between the heat exchanger 150 and one of the respective actuator drive electronic components 60i, 60ii). This can be seen more clearly in FIG. 1B, which depicts an end view of the droplet ejection head 100 of FIG. 1A. It may be understood that this arrangement is not essential and in other arrangements the respective actuator drive electronic components 60i, 60ii may be interposed between the heat exchanger 150 and the respective PCBs 70i, 70ii.

FIG. 1C depicts a cross-section AA of the droplet ejection head 100 of FIG. 1A, as indicated by the dashed line AA in FIG. 1B, showing the fluid paths 144,145 inside the droplet ejection head 100. The droplet ejection head 100 comprises an actuator component 90 and an inlet path 144 to supply fluid to the actuator components 90 and an outlet path 145 to remove fluid from the actuator component 90. Although not shown in FIG. 1A-Fig. 1C, the actuator component 90 comprises a plurality of fluid chambers, each fluid chamber comprising at least one nozzle. The fluid chambers are actuable to eject one or more droplets of fluid via the at least one nozzle in response to ejection instructions. It may be generally understood that the plurality of fluid chambers are fluidically connected at a respective first end to the inlet path 144 and are fluidically connected at a respective second end to the outlet path 145. The outlet path 145 comprises a heat exchanger 150 arranged serially downstream of the actuator component 90.

It can be seen that, in this embodiment, also as described above with reference to FIG. 1B, there are two actuator drive electronic components 60 (in this case 60i, 60ii) arranged adjacent to the heat exchangers 150, one on either side of the heat exchanger 150. Therefore, the present invention is directed to cooling the actuator drive electronic components 60 using a heat exchanger 150 located downstream of the actuator component 90 and arranged adjacent to actuator drive electronic components 60, with the return (un-ejected) fluid from the actuator component 90 passing through the heat exchanger 150 and removing heat therefrom.

The fluid inlet path 141 may be connected to the first ends of the fluid chambers via one or more inlet manifold chambers. The fluid may pass through the fluid chambers, with a proportion of the fluid being ejected from one or more of the nozzles in response to ejection instructions. The remainder of the fluid, the return fluid, may pass through the fluid chambers. The fluid chambers may be connected to one or more return manifold chambers at their respective second ends, via which they may be fluidically connected to the outlet path 145.

It may be generally understood that the nozzles may be arranged in an array, extending in an array direction 10 (for example in the x-direction) and the droplets may be ejected from the nozzles towards a media in an ejection direction 16 (for example in the z-direction), where the nozzles have their ejection openings in a media facing surface 80 of the droplet ejection head 100. The fluid chambers may extend from their first end to their second end in a fluid chamber extension direction 5 (for example the y-direction). It may be understood that, in general, in operation, the media facing surface 80 will be appropriately aligned with the media such that droplets ejected in the ejection direction 16 land in the desired location on the media.

It can be seen that, in the embodiment of FIG. 1A-Fig. 1C, the outlet path 145 comprises a heat exchanger 150 arranged serially downstream of the actuator component 90, and that, in this embodiment, the outlet path 145 comprises three main parts—a first part 146, fluidically connecting the actuator component 90 to the heat exchanger 150, a second part—the heat exchanger 150 comprising the heat exchanger fluid path 151, and a third part 147, connecting the heat exchanger 150 to the fluid return path 142. It can be seen that the heat exchanger fluid path 151 comprises a return loop such that there are two legs 151_a, 151_b, or straight fluid path sections, arranged perpendicular to the ejection direction 16. The heat exchanger fluid path 151 has a depth 158 (not shown in FIG. 1A-FIG. 1C) in the depth direction 5 (the y-direction).

It can further be seen that the two legs 151_a, 151_b are separated by a wall 153, where the wall 153 is perpendicular to the ejection direction 16. It can also be seen that the wall 153 is a peninsula in cross-section, i.e., it is mostly, but not entirely, contained within the fluid path in cross-section, being attached to the outer wall of the heat exchanger 150 at one end, so that it has a base or root 153_r, in this arrangement, near the inlet 151 in to the heat exchanger 150 in the array direction 10.

The first and third parts 146,147 of the outlet path 145 may be, for example, tubes or pipes, as may the inlet path 144. It may be generally understood that the inlet path 144 and the outlet path 145 may comprise suitable connectors to enable fluid-tight connections within the droplet ejection head 100 and to the external fluid path 143.

It can be seen from FIG. 1A and FIG. 1B that the actuator drive electronic components 60i,60ii are arranged adjacent to the heat exchanger 150; in this case, one either side and adjacent to the heat exchanger 150. The heat exchanger 150 comprises a fluid path 151, such that, in use, heat transfers from the actuator drive electronic components 60 to the one or more heat exchangers 150 and is removed from the droplet ejection head, via the return fluid in the outlet path 145. It may be generally understood that, in this arrangement, where the PCBs 70i, 70ii are respectively interposed between the heat exchanger 150 and the actuator drive electronic components 60i, 60ii, the PCBs 70i, 70ii are designed such that heat may be transferred through the PCBs 70i, 70ii to the heat exchanger 150, i.e., that the actuator drive electronic components 60i, 60ii are thermally connected to the heat exchanger 150 via a thermally conductive path 70_v through the PCBs 70i, 70ii. The heat exchanger 150 may comprise one or more high thermal conductivity materials, for example, it may comprise a thermally conductive polymer, or it may comprise a suitable metal or metal alloy with high thermal conductivity, such as aluminium or aluminium alloy.

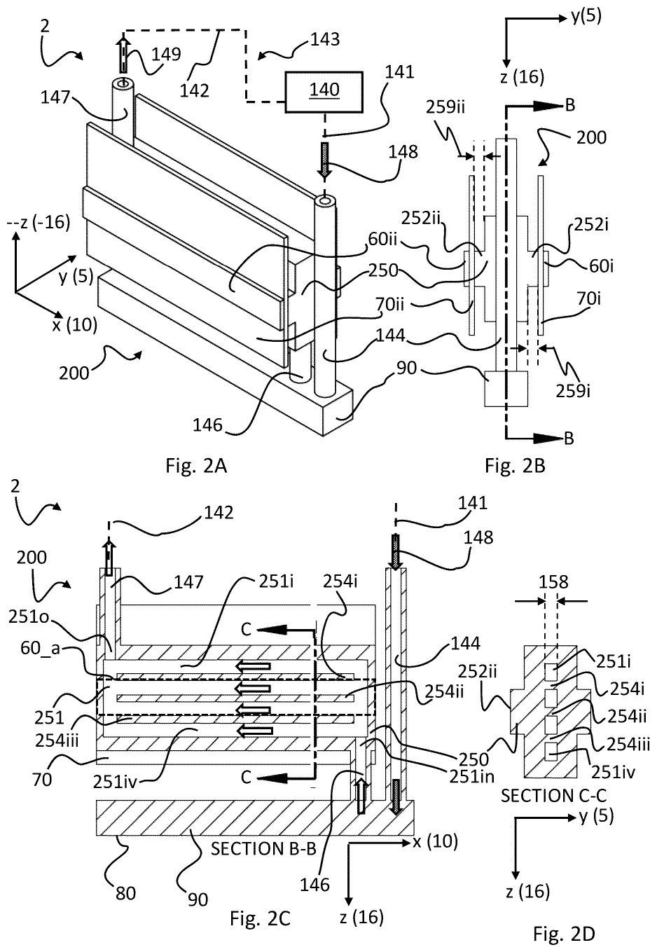

It can be seen from FIG. 1A (and FIG. 2A) that an area demarcated by the actuator drive electronic components 60 is substantially contained within an area in the same plane demarcated by the heat exchanger 150 and, preferably, within an area in the same plane demarcated by the fluid path 151. It can further be seen that the fluid path 151 is a serpentine-shaped fluid path 151, where the fluid path 151 comprises one return loop, in this case with an outward leg 151_a (i.e. away from position of the first part 146 of the outlet path 145 in the negative array direction 10) and an inward leg 151_b (back to the position of the first part 146 of the outlet path 145 in the positive array direction 10). This arrangement, where the actuator drive electronic components 60i, 60ii are arranged aligned with the heat exchanger 150, may be preferable so as to maximise the heat transfer from the actuator drive electronic components 60i, 60ii to the heat exchanger 150, when operating the droplet ejection head 100.

FIG. 2A depicts an apparatus 2 for droplet ejection, similar to that of FIG. 1A, comprising a fluid supply 140, an external fluid path 143 which comprises a fluid inlet path 141 and a fluid return path 142, and a droplet ejection head 200, according to another embodiment of the invention. The droplet ejection head 200 comprises a heat exchanger 250, the heat exchanger 250 comprises two protrusions, one either side, adjacent to the actuator drive electronic components 60 such that the protrusions have heat exchange interface surface(s) 252i, 252ii aligned with the actuator drive electronic components 60. The protrusions can be seen more clearly in FIG. 2B, which depicts an end view of the droplet ejection head 200 of FIG. 2A. It can further be seen that the respective actuator drive electronic components 60i, 60ii are arranged on the respective PCBs 70i, 70ii such that the PCBs 70i, 70ii are interposed between the protrusion heat exchange interface surface(s) 252i, 252ii and the actuator drive electronic components 60i, 60ii. The protrusions heat exchange interface surface(s) 252i, 252ii enable contact between the PCBs 70i, 70ii and the heat exchanger 250 in a designated area such that the area demarcated by the respective actuator drive electronic components 60i, 60ii is substantially contained within the area demarcated by the respective heat exchange interface surface(s) 252i, 252ii. This may ensure that the majority of the heat from the actuator drive electronic components 60i, 60ii passes through a limited cross-sectional area (that of the heat exchange interface surface(s) 252i, 252ii adjacent to them) and into the heat exchanger 250. To further aid in this control of the heat transfer, the protrusions also mean that the remainder of the PCB(s) 70i, 70ii are separated from the heat exchanger 250 by an air gap 259i, 259ii, as seen in FIG. 2B. This arrangement ensures that the majority of the heat transfer, from the actuator drive electronic components 60i, 60ii to the heat exchanger 250, passes through the demarcated areas. In other words, the protrusions provide for an air gap 259,859 between the PCBs 70 and the heat exchanger 250, except in the region of alignment with the actuator drive electronic components 60.

FIG. 2C depicts a cross-section BB, of the droplet ejection head 200 of FIG. 2A, indicated by the line BB in FIG. 2B, showing that the heat exchanger 250 comprises a plurality of horizontal paths 251i-251iv separated by walls 254i-254iii in the heat exchanger fluid path 251. It can be seen that the walls 254i-254iii are parallel to the depth direction 5 and perpendicular to the ejection direction 16 and that, in the z-x cross-section, they are like islands encapsulated or contained within the fluid path 251 (this can be compared to the peninsula wall 153 of FIG. 1C, which, in z-x cross-section, is not fully contained within the fluid path 151). The area 60_a demarcated by the actuator drive electronic components 60 is indicated by a dashed line on FIG. 2C. It can be seen that in the same plane (in this case the plane of the ejection direction 16 and the array direction 10) the area demarcated by the fluid path 251 in a plane is substantially greater than the area 60_a demarcated by the actuator drive electronic components 60 in the same plane and that the area of the heat exchanger 250 in the plane is substantially greater than the area 60_a in the plane demarcated by the actuator drive electronic components 60.

Turning now to FIG. 2D, which is a cross-section of the heat exchanger 250, indicated by the line CC in FIG. 2C, it can be seen that the heat exchanger fluid path 251 has a depth 158 in the depth direction 5. It can further be seen that the island walls 254 extend across all of the heat exchanger fluid path 251 in the depth direction 5. There are three walls 254i-254iii in the embodiment of FIG. 2A-FIG. 2D, but it may be understood that this is not limiting and there may be one or more walls 254, for example there may be a plurality of walls 254i-254n where n is any whole number.

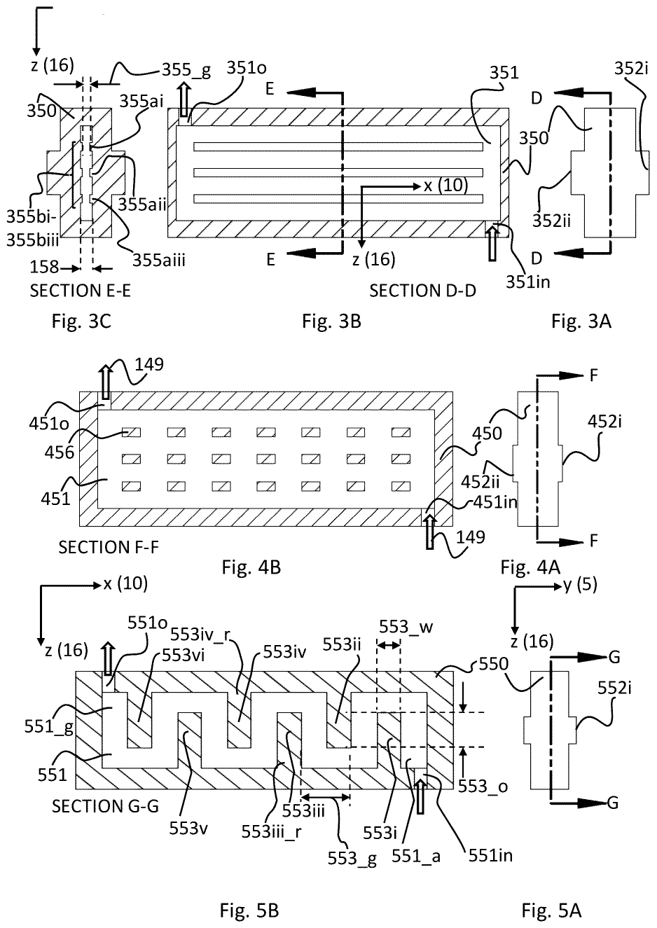

FIG. 3A-FIG. 3C depict another embodiment, similar to that of FIG. 2A-2D. Only the heat exchanger 350 is shown in FIG. 3A-3C, where the heat exchanger 350 has ridges 355ai-355biii separated by a gap 355_g in the centre of the heat exchanger fluid path 351 in the depth direction 5. This can be seen clearly in the cross-section E-E of FIG. 3C, which is indicated by the section line E-E in FIG. 3B (in comparison to the cross-section C-C of FIG. 2D of the heat exchanger 250 where the walls 254 extend fully across the heat exchanger fluid path 251 in the depth direction 5). It can be seen that the gap 355_g is less than the depth 158 in the depth direction 5, and it may be generally understood that, for arrangements having a gap, the gap 355_g is greater than zero and less than the depth in the depth direction (158>355_g>0).

In this embodiment the ridges 355 are aligned and symmetrical in the section E-E (in the z-y plane), but it may be understood that this is not essential and other arrangements may be contemplated. For example, in other arrangements the ridges 355, on opposing sides of the fluid path 351 in the z-y plane, may be alternately staggered on opposing sides of the gap 355_g in the z-direction.

Turning now to FIG. 4A-FIG. 4B, these depict, respectively, an end view of a heat exchanger 450 and a cross-section FF, as indicated by dashed line FF in the end view of FIG. 4A. The heat exchanger 450 is suitable for use in an alternative embodiment of a droplet ejection head and comprises a plurality of pillars 456 distributed, in the heat exchanger fluid path 451, in both the ejection direction 16 and the array direction 10. As before, the heat exchanger fluid path 451 may have a depth 158 in the depth direction 5 (not shown), with the pillars extending fully across the heat exchanger fluid path 451 in the depth direction 5. It may be understood that, in an alternative embodiment, in a similar manner to the embodiment of FIG. 3A-FIG. 3C, the pillars 456 may be replaced by towers that do not span the full width of the fluid path 451 in the depth direction 5. Such towers may extend partially across the fluid path 451 such that there is a gap, similar to the gap 355_g of FIG. 3C, separating the tops of the towers on opposing sides of the fluid path 451 in the depth direction 5.

Considering now FIG. 5A-FIG. 5B, these depict, respectively, an end view of a heat exchanger 550 and a cross-section GG, as indicated by dashed line GG in the end view of FIG. 5A. The heat exchanger 550 is suitable for use in an alternative embodiment of a droplet ejection head and comprises a plurality of return loops in the heat exchanger fluid path 551. The return loops are formed by peninsula walls 553i-553vi that are staggered (in the array direction 10) and arranged alternately, on opposite sides of the heat exchanger fluid path 551, in the ejection direction 16. The straight legs 551_a-551g of the return loops are, therefore, aligned with and parallel to the ejection direction 16. Adjacent peninsula walls 553i-552vi are staggered, in the array direction 10, by a distance 553g and each peninsula wall 553i-552vi has a width, in the array direction 10, of 553_w where 553_g>553_w so as to create a serpentine, or meandering, fluid path 551 around the peninsula walls 553i-553vi. The peninsula walls 553i-552vi overlap in the ejection direction 16 by an overlap distance 553_o, where the overlap distance 553_o>0. There are 6 peninsula walls 553i-553vi in the embodiment of FIG. 5A-FIG. 5B but it may be understood that this is not essential and there may be one or more peninsula walls 553.

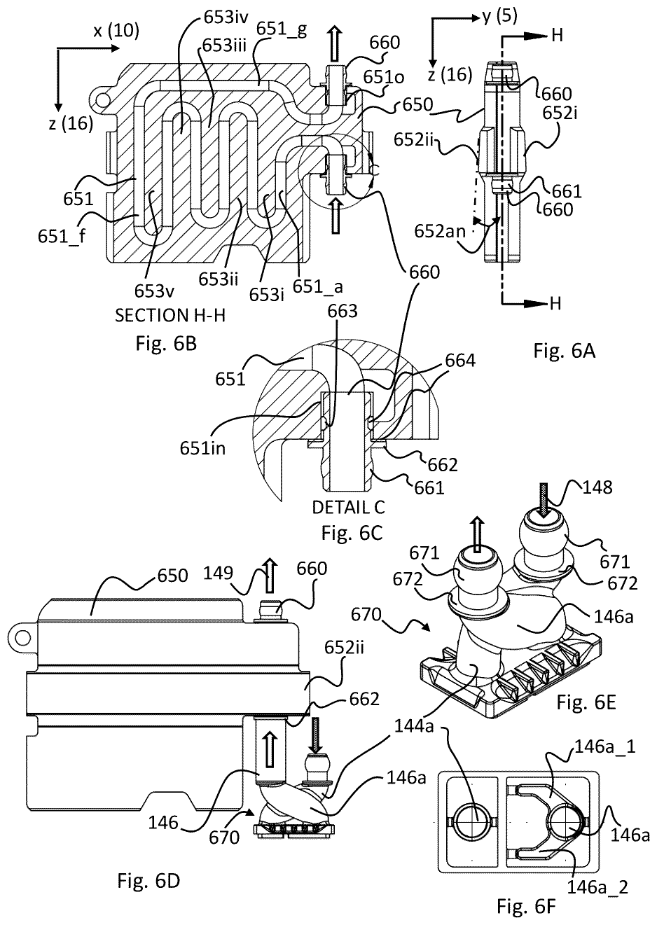

FIG. 6A depicts an end view of a heat exchanger 650, suitable for use in an alternative embodiment, comprising a heat exchanger fluid path 651 with a serpentine path, similar to that of FIG. 5B and where the protrusion heat exchange interface surfaces 652i, 652ii are at an angle 652an to the ejection direction 16, such that when the PCBs 70i, 70ii are placed adjacent to the respective protrusion heat exchange interface surfaces 652i, 652ii the PCBs 70i, 70ii are likewise at an angle 652an to the ejection direction 16. It may be understood that this is by no means essential, but that such an arrangement may be suitable where there are large components that need to be attached to the PCBs 70i, 70ii within a limited footprint available for a droplet ejection head.

FIG. 6B depicts a cross-section HH of the embodiment of FIG. 6A, indicated in FIG. 6A, showing the fluid path 651 with a serpentine shape with return loops with rounded corners and straight legs 651_a-651_f aligned with and parallel to the ejection direction 16 and further comprising a loop, prior to the heat exchanger outlet 651o, with a straight leg 651_g perpendicular to the ejection direction 16. The main differences compared to FIG. 5B are that, in this embodiment, the heat exchanger 650 comprises return loops with rounded corners. This may be preferable for use with fluids comprising large percentages of particulates, to prevent build-up of deposits in the bends, and also for improved smoothness of fluid flow in the heat exchanger 650. The other main differences are that the straight legs 651_a-651_f are not all the same length, and are not all oriented the same way, with 651_g being largely perpendicular to the other legs 651_a-651_f. Such an arrangement, where not all the fluid path legs 651_a-651_g have the same length and/or the same orientation, may be used to maximise the length and/or the wetted surface of the fluid path 651 within the heat exchanger 650 so as to maximise the heat transferred to the fluid in the fluid return path 142. In general, the design principle may be to maximise the heat transfer from the heat exchanger to the return fluid, this may be done by increasing the surface area of the fluid path (i.e., the wetted surface area) and/or by increasing the residence time of the return fluid in the heat exchanger (i.e., by increasing the length of the heat exchanger fluid path 651).

The length of the heat exchanger fluid path 651 within the heat exchanger 650 may be limited by the proximity of adjacent legs to each other, and the possibility of heat exchange between the fluid in the legs such that the route of the fluid path 651 may be chosen to maximise the cooling effect on the actuator drive electronic components 60 by providing the most efficient balance between the length and/or wetted surface area of the fluid path 651 and the proximity of adjacent sections of the fluid path 651 to each other. Further, the cooling effect may need to be balanced against fluidic pressure losses in the heat exchanger fluid path 651 by maximising the fluid path wetted surface area within the heat exchanger 650 whilst minimising the fluidic pressure losses within the heat exchanger, i.e., by minimising the fluidic pressure losses within the heat exchanger fluid path 651. For example, by controlling the cross-sectional area of the heat exchanger fluid path 651 and/or the length of the fluid path and/or the smoothness of the path (i.e., by smoothing direction changes of the heat exchanger fluid path 651 by designing it with rounded corners and using chamfers and blended sections on sharp edges). The meandering heat exchanger fluid path 651 may improve fluid mixing and thereby improve the thermal transfer from the wetted surface area of the heat exchanger fluid path 651 into the return fluid.

FIG. 6C depicts a detail C of the cross-section HH of FIG. 6B, indicated in FIG. 6B, showing a spigot 660 arranged to connect the outlet path 145, specifically the first part 146 of the outlet path 145 to the heat exchanger inlet 651in. A spigot 660 is also arranged at the heat exchanger outlet 651o to connect to the third part 147 of the outlet path 145 (not shown). The spigot 660 may have external spherical features 661 over which flexible pipes or tubes may be fitted, for example to connect the first stage 146 of the outlet path 145 to the heat exchanger inlet 651in (see FIG. 6D for example) and the third stage 147 of the outlet path 145 to the heat exchanger outlet 651o (not shown here). For example, a flexible tube or pipe may be used that has a diameter that is smaller than the spherical feature 661, and it may have a diameter that is smaller than the external diameter of the portion of the spigot that the first part 146 of the outlet path 145 connects to. The flexible tube or pipe may be deformed as it is pushed over the spherical feature 661. These spherical features 661 may accommodate greater variability in alignment between fluidically connected components, so that there is greater flexibility in their respective positions in a droplet ejection head. For example, it may give a greater allowable range of positioning tolerance between the heat exchanger 650 and the actuator component 90 (not shown), whilst maintaining a fluid tight connection between them. It can further be seen that the spigot 660 comprises a spherical indentation 663 which aligns with a portion of the cylindrical feature at the heat exchanger inlet 651in (and similar at the outlet 651o) this spherical indentation 663 may comprise a location for a fluidic sealing component such as an O-ring, or may, preferably, be partially or fully filled with an adhesive/sealant 664 to ensure fluid-tight permanent internal connections. Additionally, an adhesive or sealant 664 or a fluidic sealing component may also be placed between the collar 662 on the spigot 660 and the heat exchanger 650. Accordingly, a droplet ejection head as described herein may have a fluid path 651 comprising cylindrical features at the inlet 651in and the outlet 6510 to receive a portion of spigots 660; and where the interfaces between the spigots 660 and the inlet 651 in and the outlet 6510 comprise adhesive and/or sealant and/or a fluidic sealing component. It may further be understood that, in a similar manner, the first part 146 of the outlet path 145 may be connected to the actuator component 90 using such a spigot 660, optionally with such one or more sealant features 664. Additionally, the inlet path 144 may be connected to the actuator component 90 using such a spigot 660. Alternatively, a diverter 670 (see FIG. 6D) comprising similar spherical features 671 to those of the spigot 660 may be utilised. FIG. 6D depicts a side view of the heat exchanger 650 and spigots 660 of FIG. 6A-FIG. 6C and further depicts a part of the outlet path 145 and a diverter 670 to connect the first part 146 of the outlet path 145 to the actuator component 90 (not shown). FIG. 6E depicts the fluid diverter of FIG. 6D in greater detail and FIG. 6F depicts the underside of the fluid diverter of FIG. 6E and FIG. 6D.

It can be seen in FIG. 6D that the first part 146 of the outlet path 145 may comprise a flexible tube or pipe, for example, which may be pushed over the spherical feature 661 of spigot 660 and over the spherical feature 671 of the outlet path 146a of the diverter 670. For example, the flexible tube or pipe may have a diameter that is smaller than the spherical feature 661, and it may have a diameter that is smaller than the external diameter of the portion of the outlet path 146a of the diverter 670 that the first part 146 of the outlet path 145 connects to. The flexible tube or pipe may be deformed as it is pushed over the spherical feature 661. In a similar manner (not shown) the diverter 670 may connect the inlet path 144 to the actuator component 90, for example, the inlet path 144 may comprise a flexible tube or pipe, similar to those described above with respect to the outlet path 145, which may be pushed over the spherical feature 671 of the inlet path 144a of the diverter 670. The diameter of the flexible tube may, as before, be smaller than the spherical feature 671 of the diverter and may be smaller than the external diameter of the inlet path 144a of the diverter 670 that the inlet path 144 connects to. As described above, the use of such spherical features 671 and flexible tubes makes it easier to align component parts such as the actuator component 90, the inlet to the droplet ejection head (not shown) the heat exchanger 650, etc. within the droplet ejection head, whilst maintaining fluid-tight connections, because their relative positions do not have to be so tightly defined-the design can tolerate more variability in their relative positions.

The inlet path 144a and the outlet path 146a of the diverter 670 may further comprise collars 672 and adhesive and/or sealant and/or a fluidic sealing component may be placed between the collars 672 and the respective inlet path 144 and the first part 146 of the outlet path 145. The diverter 670 may be fluidically connected to the first ends of the plurality of fluid chambers via the inlet path 144a of the diverter 670. The inlet path 144a may be connected to the fluid chambers via an inlet manifold chamber, as described above. Similarly, the second ends of the plurality of fluid chambers may be connected to the outlet path 146a of the diverter 670; this may be via an outlet manifold chamber, as described above. The diverter is a compact arrangement to supply fluid from the inlet path 144 to the actuator component 90 and to remove fluid from the actuator component 90 to the outlet path 145 with the spherical features 761 providing for fluid-tight connections and enabling reductions in the positional tolerance requirements between the heat exchanger 650 and the actuator component 90. In general, therefore the diverter 670 fluidically connects the inlet path 144 and the outlet path 145 to the actuator component 90 and comprises spherical features 671 to enable fluid-tight connections to the inlet path 144 and the outlet path 145 respectively.

The fluidic connections of the inlet path 144a and outlet path 146a can be seen in the image, of the under-side of the fluid diverter of FIG. 6E and FIG. 6D, in FIG. 6F. It may be understood that, in some arrangements, there may be two arrays of fluid chambers extending in the array direction 10 with their respective first ends connected to an inlet manifold chamber. The respective second ends of the first array may be connected to one of two outlet manifold chambers and the respective second ends of the second array may be connected to a second one of two outlet manifold chambers (in other words, there may be one inlet manifold chamber supplying fluid to two arrays of fluid chambers and there may be an outlet manifold chamber per array of fluid chambers to remove fluid from a respective array). Such an arrangement allows for a greater nozzle density whilst limiting the number of manifold chambers required. In such an arrangement, the fluid paths removing fluid from the two outlet manifold chambers may connect to each other, for example, they may connect in or adjacent to the diverter 670. In the arrangement of FIG. 6D-6F, two sub-outlet paths 146a_1, 146a_2 remove fluid from the two outlet manifold chambers in the actuator component 90 (not shown). The sub-outlet paths 146a_1, 146a_2 connect to the outlet path 146a in the diverter 670, such that the heat exchanger 650 may be arranged in series downstream of the two outlet manifold chambers. In general, the diverter 670 may fluidically connect one or more second manifold chambers to a respective heat exchanger, as described herein. It may further be understood that there may be arrangements with one or more inlet manifold chambers, with suitable path splitters to supply fluid from the inlet path 144 to, if there are more than one, the inlet manifold chambers.

It may generally be understood that such spigots 660 and diverter components 670 and shaping of the various connection points, at inlets and outlets, may be incorporated into any droplet ejection heads as described herein and used to connect to the inlet 651in and outlet 651o of any heat exchanger as described herein. It may further be understood that the relative locations of any of the internal and external spherical features of the spigots 660 may, instead, be located in the diverter 670 and/or the inlet 651in and outlet 651o to the heat exchanger fluid path 651, and/or the fluid path 144, 146 tubes may, instead, comprise suitable spherical indentation 663 or external spherical features 661, with the spigot 660 and/or the diverter 670 designed to match accordingly.

It may generally be understood that, when the heat exchanger 650 comprises part of a droplet ejection head, the plurality of fluid chambers may be fluidically connected at a first end to one or more inlet manifold chambers, where the inlet manifold chamber is fluidically connected to the inlet path 144, and the plurality of fluid chambers may be connected at a second end to one or more outlet manifold chambers, the one or more outlet manifold chamber chambers being fluidically connected to the outlet path 145, and where the one or more outlet manifold chambers are fluidically connected in series to a respective heat exchanger 650. To enable fluid-tight connections between its parts, the outlet path 145 may comprise one or more spigots 660, each of the spigots 660 comprising one or more external spherical features 661, where each respective external spherical feature 661 is arranged to provide fluid-tight connection to a part of the outlet path 145. For example, a fluid pipe or tube, (see FIG. 6D) may be fitted over a respective spherical feature 661 such that there is a pipe or tube per respective spherical feature 661.

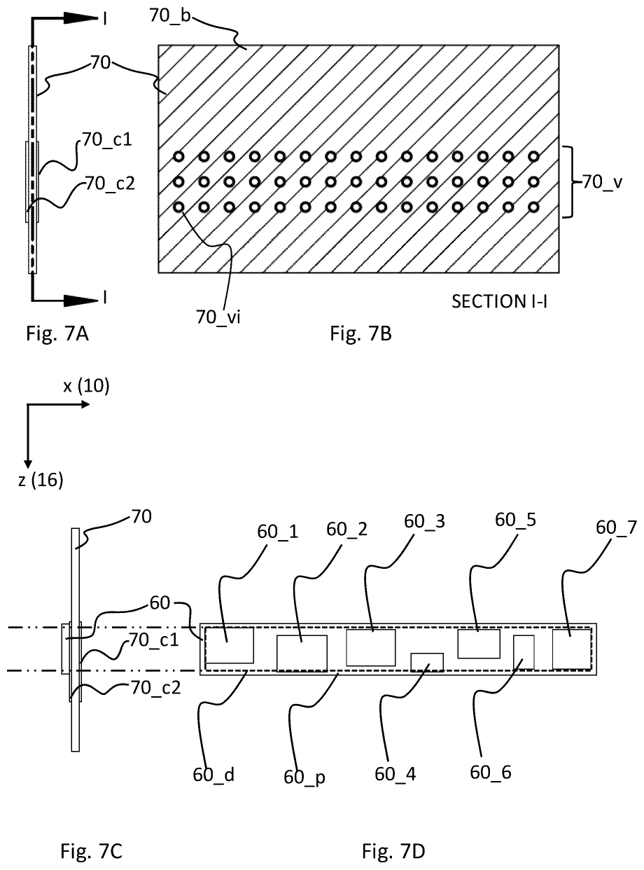

Turning now to FIG. 7A, this depicts an end view of a PCB 70 suitable for use in embodiments of the present invention as described herein. It can be seen from FIG. 7A that the PCB comprises first and second thermally conductive regions 70_c1, 70_c2, arranged on opposite sides of the PCB 70. The thermally conductive regions 70_c1,70_c2 may comprise a thermally conductive material, such as copper, or gold, or another metal or thermally conductive material. The first and second thermally conductive regions 70_c1,70_c2 may be thermally connected to one another by one or more thermally conductive paths 70_v. The location of the first thermally conductive region 70_c1 may align with the heat exchange interface surfaces of the protrusions seen in various embodiments described herein, and the second thermally conductive region 70_c2 may correspond to the area demarcated by the actuator drive electronics 60, when the actuator drive electronics 60 are mounted on the PCB 70, or the second thermally conductive region 70_c2 may have an area on the PCB that encompasses that demarcated by the actuator drive electronics 60. In this way, when the PCB 70 is installed in a droplet ejection head, as described herein, the first thermally conductive region 70_c1, may be aligned with, and arranged adjacent to, the heat exchange interface surfaces 252-852 of the one or more protrusions, and the second thermally conductive region 70_c2 may be aligned with, and arranged adjacent to, the area demarcated by the actuator drive electronic components 60. The thermally conductive regions 70_c1,70_c2 may aid in focusing or funnelling heat transfer from the actuator drive electronic components 60, arranged in the demarcated region, into the heat exchanger 250-650 and may thereby reduce or prevent heat transferring to other components, such as other electrical components, on the PCB 70.

Turning now to FIG. 7B, this depicts a cross-section II of the PCB 70 of FIG. 7A, indicated in FIG. 7A, showing the internal structure of the PCB 70 and that the thermally conductive regions 70_c1,70_c2 may be thermally connected to one another by one or more thermally conductive paths 70_v, where the thermally conductive paths 70_v may comprise a plurality of vias 70_vi which may be formed by drilling, for example laser drilling, a plurality of holes in the PCB 70, and lining or filling the plurality of holes with a thermally conductive material, such as copper, or gold, or another metal or thermally conductive material, such that the thermally conductive regions and the thermally conductive paths 70_v comprise a metal. It may further be understood that the PCB 70 may comprise one or more layers 70_b, comprising material such as fibreglass, with the vias 70_vi passing through one or more of the layers 70_b. In one possible arrangement the PCB 70 may comprise a plurality n of layers 70_b_1-70_b_n, with vias 70_vi formed in each layer. The vias 70_vi in each layer 70_b_i may not align with the vias in the preceding layer 70_b_(i−1); instead, an interface thermally conductive region 70_ci may lie between adjacent layers 70_b of material, thermally connecting the vias 70_vi in one layer to the vias 70_vi in the adjacent layer, with the arrangement so formed providing a thermally conductive path 70_v through the PCB connecting the first and second thermally conductive regions 70_c1,70_c2. The interface thermally conductive region(s) 70_ci may demarcate an area which is substantially the same as those areas demarcated by the first and/or second thermally conductive regions 70_c1,70_c2 respectively.

FIG. 7C depicts the end view of a PCB 70 of FIG. 7A, with an actuator drive electronic component 60 arranged adjacent to and attached to the second thermally conductive region 70_c2. FIG. 7D depicts the actuator drive electronic component 60 of FIG. 7C viewed from the interface side (i.e., viewing the face that is arranged adjacent to and facing the second thermally conductive region 70_c2 in FIG. 7C). It can be seen that the actuator drive electronic component 60 comprises a plurality of actuator drive electronic components 60_1-60_7 (it may be understood that the number is not limiting and there may be one or more actuator drive electronic components 60) and that the area demarcated by the actuator drive electronic component 60, where there is more than one, is bounded by the dotted line 60_d that passes through the outermost edges of the plurality of actuator drive electronics components 60_1-60_7. In other words, it may generally be understood that the actuator drive electronic components 60 may respectively comprise one or more co-located components 60_1-60_n, where n is a whole number, where the components may be co-located on an area adjacent to the heat exchanger 150, for example, the one or more components may be co-located on a sub-area of the respective PCBs 70i,70ii; the sub-area may be in the centre of the PCBs 70i,70ii in the ejection direction 16. Where there are thermally conductive regions 70_c1,70_c2, the co-location sub-area may be such that the actuator drive electronic components 60 are substantially contained within the area of the second and/or first thermally conductive region 70_c2,70_c1. Whether there is one or more actuator drive electronic components 60, it may be understood that the area they demarcate may be substantially contained within the area of the second thermally conductive region 70_c2 in the same plane. It may further be understood that one or more actuator drive electronic components 60 may be potted or encapsulated in a cover 60_p, as shown in FIG. 7D. The area demarcated by the cover 60_p may also be substantially contained within the area of the second thermally conductive region 70_c2 in the same plane.

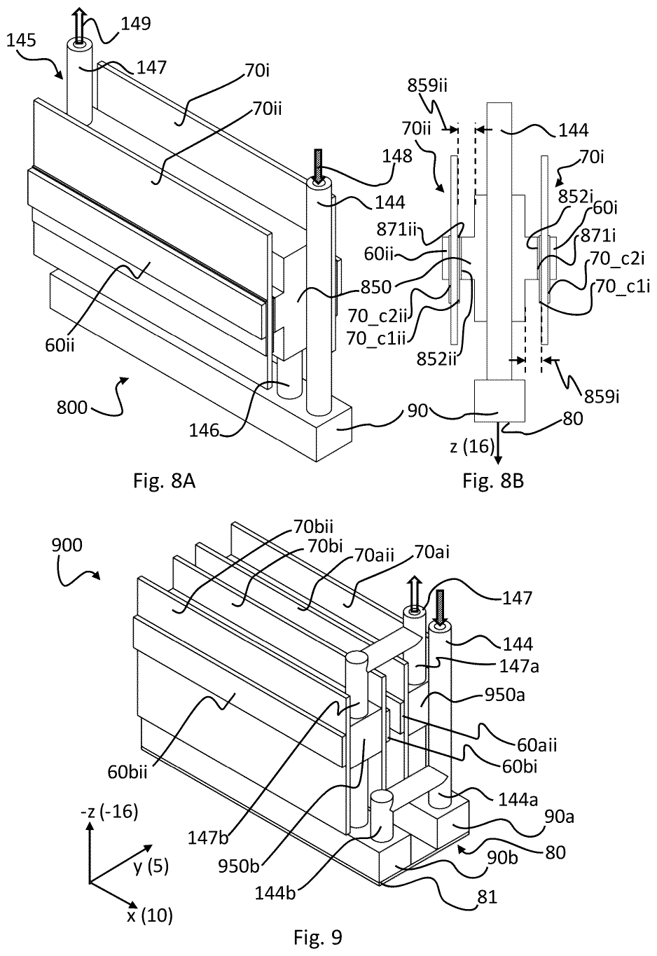

FIG. 8A depicts a droplet ejection head 800 according to another embodiment comprising a PCB similar to that of FIG. 7A and FIG. 7B but with a thermally conductive bonding layer 871i,871ii arranged between respective protrusion heat exchange interface surface(s) 852i,852ii on the heat exchanger 850 and a first thermally conductive region 70_c1i,70_c1ii of a respective PCB 70i,70ii. The thermally conductive bonding layer 871i,871ii may comprise a thermally conductive resin and/or a thermally conductive adhesive. The thermally conductive bonding layer 871i,871ii may comprise a heat curable material. It may comprise a polymer resin with a filler to improve the thermal conductivity, the filler may, for example, be a ceramic or a metal. Alternatively, a liquid metal may be used as the thermally conductive bonding layer 871i,871ii, a liquid metal being a flowable alloy which may be used to fill a small gap between the PCB and the heat exchanger and thereby provide a thermal path therethrough. Other alternatives are thermally conductive pastes, or semi-solid, deformable, thermally conductive pads. In general, the thermally conductive bonding layer 871i,871ii bonds a respective PCB 70i,70ii to a respective heat exchange interface surface 852i,852ii of a respective protrusion.

The second thermally conductive regions 70_c2i,70_c2ii of the respective PCBs 70i,70ii of FIG. 8A may be arranged adjacent to the actuator drive electronic components 60i,60ii, in a similar manner to that shown in FIG. 7C. The actuator drive electronic components 60 may be attached to the second thermally conductive regions 70_c2i,70_c2ii using wire bonding or another thermally conductive attachment method, which may include the use of thermally conductive glues or resins. The area demarcated by the actuator drive electronic components 60 may be substantially contained within the areas demarcated by the first and second thermally conductive regions 70_c1i, 70c1ii,70_c2i,70_c2ii.

FIG. 8B depicts an end view of the droplet ejection head of FIG. 8A indicating the presence of an air gap 859i,859ii between the respective PCBs 70i,70ii and the heat exchanger 850, except in the region of the protrusion. It can be seen that in the embodiment of FIG. 8A-FIG. 8B the droplet ejection head 800 comprises two actuator drive electronic components 60i,60ii to one heat exchanger 850, one arranged to either side of the heat exchanger 850. It may be understood that each actuator drive electronic component 60i,60ii may comprise a plurality of actuator drive electronic components 60_1-60_n, where n is whole number, as in FIG. 7D. In use, fluid may be supplied to the actuator component 90 via the inlet path 144. The heat exchanger 850 is arranged in series downstream of the actuator component 90 and fluidically connected to it by a first part 146 of the outlet path 145. Fluid leaves the heat exchanger 850 via the third part 147 of the outlet path 145. The PCBs 70i,70ii each comprise first and second thermally conductive regions 70_c1i, 70_c1ii, 70_c2i,70_c2ii. The respective first thermally conductive regions 70_c1i, 70_c1ii are aligned with and arranged adjacent to respective heat exchange interface surfaces 852i,852ii of the one or more protrusions. Thermally conductive bonding layers 871i,871ii bond a respective PCB 70i,70ii to a respective heat exchange interface surface 852i,852ii of a respective protrusion. The respective second thermally conductive region 70_c2i,70_c2ii are aligned with, and arranged adjacent to, the respective areas demarcated by the respective actuator drive electronic components 60i,60ii.

FIG. 9 depicts a droplet ejection head 900, according to another embodiment, comprising two actuator components 90a,90b, a nozzle plate 80, and further comprising two heat exchangers 950a,950b arranged adjacent to the actuator drive electronic components 60ai (not seen in this view), 60aii,60bi,60bii. It can be seen that the inlet path 144 splits into two sub-paths 144a, 144b to supply fluid to the respective actuator component 90a,90b, which share a nozzle plate 80, though it may be understood that this is by no means essential and, in other arrangements, each actuator component 90a,90b may have their own nozzle plate 80a,80b. It can also be seen that the third part 147 of the outlet path 145 is connected to the respective heat exchangers 950a,950b by two sub-paths 147a, 147b.

As in previous droplet ejection heads described herein, the heat exchangers 950a,950b are arranged serially downstream of the respective actuator components 90a,90b. In general, a droplet ejection head may comprise two or more actuator components 90 and two or more respective heat exchangers, as described herein, which may be arranged serially downstream of each respective one of the two or more actuator components. In other words, in some arrangements, there may be a 1:1 relationship between a respective heat exchanger 950 and a respective actuator component 90. Further, it can be seen that in FIG. 9, for each respective heat exchanger 950a,950b there are two or more actuator drive electronic components 60ai,60aii,60bi,60bii. They are arranged such that there are two actuator drive electronic components 60i,60ii per respective heat exchanger 950, a respective one arranged adjacent to each side of a respective heat exchanger 950. It may be understood that such an arrangement is not essential, and that in other arrangements there may be only one actuator drive electronic component 60 and one PCB, with a heat exchanger as described herein arranged adjacent to the one actuator drive electronic component 60.

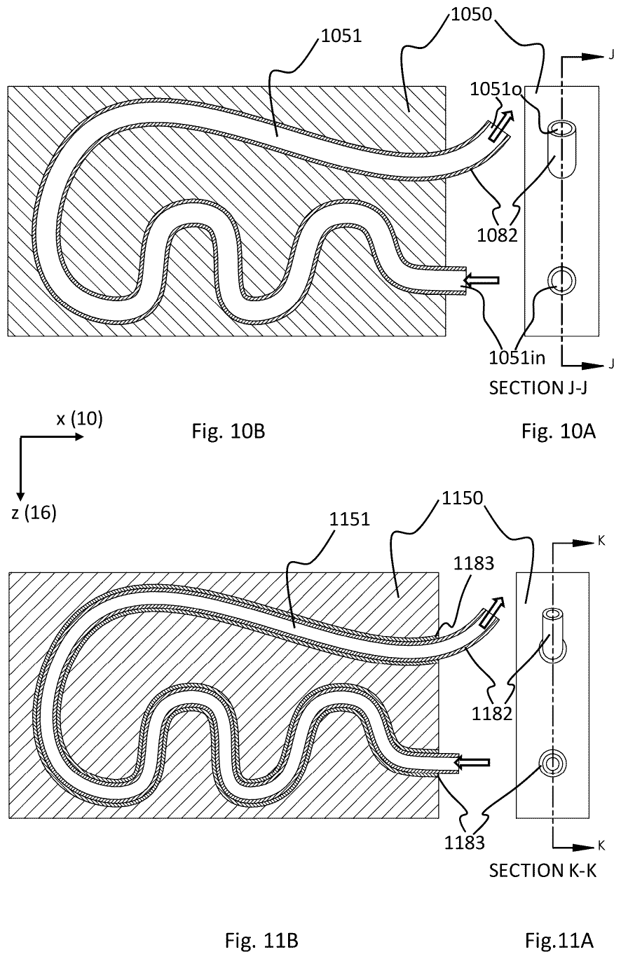

FIG. 10A depicts an end view of a heat exchanger 1050 suitable for use in an alternative embodiment comprising a heat exchanger fluid path 1051 with a serpentine shape, similar to that of FIG. 6B, where the heat exchanger fluid path 1051 additionally comprises a sleeve 1082, the sleeve 1082 comprising one or more thin-walled component(s) of continuous cross-section, for example, a pipe or tube. FIG. 10B depicts a cross-section JJ of the embodiment of FIG. 10A, as indicated in FIG. 10A, showing the heat exchanger fluid path 1051 and the sleeve 1082.

The sleeve 1082 may be formed into a serpentine or other shape. The length of the sleeve 1082, combined with its cross-sectional shape and area, wall thickness, thermal conductivity, and any other relevant characteristics, may be sufficient for the adequate transfer of heat from the one or more actuator drive electronic components 60 to the fluid in the heat exchanger fluid path 1051. The sleeve 1082 may comprise any suitable material and any suitable surface finish—e.g., chemical/mechanical, modification/coating—to be chemically resistant to fluids to be used for fluid ejection. The sleeve 1082 may be substantially surrounded by the heat exchanger 1050 and thermally connected to it by direct contact between the sleeve 1082 and one or more internal surfaces of the heat exchanger 1050 that form the shape of the heat exchanger fluid path 1051 as seen in FIG. 10B. For example, the heat exchanger 1050 may comprise two or more components which when assembled together contain a void forming the heat exchanger fluid path profile into which a substantial portion (length) of the sleeve 1082 fits. The closeness of fit between the heat exchanger fluid path profile and the sleeve 1082 and the extent and form of the fluid path that is enclosed by the heat distributor may be determined according to functional and manufacturing requirements. For example, the heat exchanger fluid path profile may fit more closely around straight portions of the sleeve 1082 than around curved portions, or not around curved portions at all (for example, the sleeve 1082 may pass through a larger void in such areas).

Alternatively, the heat exchanger 1050 may be formed around the sleeve 1082, for example by pouring a settable material with suitable thermal properties for the heat exchanger 1050 into a mould into which the sleeve 1082 has been arranged. It may be understood that to enable fluidic connection to the rest of the fluid path, the sleeve 1082 may extend beyond the mould, so as to protrude from the heat exchanger 1050, as seen in FIG. 10A and FIG. 10B. Once the material has set the heat exchanger 1050 with encapsulated sleeve 1082 may be removed from the mould, and the inlet 1051 in and outlet 1051o of the fluid path 1051 can be connected to as required.

Turning now to FIG. 11A, this depicts an end view of a heat exchanger 1150 suitable for use in an alternative embodiment. comprising a heat exchanger fluid path 1151 with a serpentine shape, similar to that of FIGS. 10A and 10B, where the heat exchanger fluid path 1151 additionally comprises a sleeve 1182 and an interface material 1183. FIG. 11B depicts a cross-section KK of the embodiment of FIG. 11A, as indicated in FIG. 11A, showing the heat exchanger fluid path 1151, the sleeve 1182 and the interface material 1183. As can be seen from FIG. 11B, the interface material 1183 provides a connection between the sleeve 1182 and the main body of the heat exchanger 1150. It might be, for example, an adhesive, or gel or putty; it may be a material that is cured to a stiff or rigid form or a paste or other material which remains soft and/or flexible.

It may be generally understood that using discrete components for the fluid path 1051,1151 and heat exchanger 1050,1150 may increase the potential for optimising selection of their individual materials for their distinct performance or other requirements. Notable performance requirements may be chemical resistance and heat-transfer respectively. For example, considering manufacturing requirements (e.g. d) below), a material could be selected for the main body of the heat exchanger 1050,1150 for ease of casting (e.g. an alloy with very low melting point)—or other process (possibly 3D-printing)—that would not be sufficiently chemically robust or readily coated/plated to make it suitable for being in fluid contact. Using a sleeve 1082,1182 for the fluid path 1051,1151 enables a different material to be chosen that may have better properties to handle the fluid in the fluid path, such as corrosion resistance, or chemical or electrical resistance and/or insulation. The interface material 1183, where present, may be chosen for its heat transfer properties and/or its bonding properties, for example.

### METHOD OF OPERATION

A droplet ejection head 100-900, as described herein, may be used to cool actuator drive electronic components 60. For example, the droplet ejection head 100-900 may comprise one or more actuator drive electronic components 60 for a droplet ejection head 100-900 where the droplet ejection head 100-900 comprises one or more actuator components 90, an inlet path 144 to supply fluid to said one or more actuator components 90 and an outlet path 145 to remove fluid from said one or more actuator components 90. The one or more actuator components 90 may comprise a plurality of fluid chambers; where the fluid chambers may respectively comprise at least one nozzle. The fluid chambers are actuable (or comprise an actuator) to eject one or more droplets, via said at least one nozzle, in response to ejection instructions. The plurality of fluid chambers may be fluidically connected, at a respective first end, to said inlet path 144 and may be fluidically connected, at a respective second end, to said outlet path 145. The outlet path 145 may comprise one or more heat exchangers 150-950 arranged serially downstream of the one or more actuator components 90. The one or more actuator drive electronic components 60 may be arranged adjacent to each of said heat exchangers 150-950. The one or more heat exchangers 150-950 may comprise one or more fluid paths 151-951, such that, in use, heat transfers from said actuator drive electronic components 60 to said one or more heat exchangers 150-950 and is removed via the return fluid (where the return fluid is the fluid that has passed through the actuator component 90 and not been ejected via a nozzle). The area demarcated by the actuator drive electronic components 60 may be substantially contained within the area demarcated by the one or more fluid paths 151-951. The cooling method may comprise, in turn:
supplying fluid to said one or more actuator components 90 via said inlet path 144; and
removing return fluid from said one or more actuator components 90 via said outlet path 145 and introducing said return fluid into the heat exchanger fluid path 151-951 such that it flows through the one or more heat exchangers 150-950 and removes heat transferred to said heat exchanger 150-950 from said actuator drive electronic components 60 via the return fluid flowing through the one or more heat exchangers 150-950.

A droplet ejection apparatus 1,2 as described herein and comprising one or more droplet ejection heads 100-900 as described herein, may have a method of operation that may comprise, in turn:
supplying fluid to the one or more droplet ejection heads 100-900 via a fluid inlet path 141;
supplying fluid to one or more actuator components 90 in respective droplet ejection heads 100-900 via one or more inlet paths 144 in a respective droplet ejection head 100-900;
ejecting a proportion of the fluid from one or more nozzles in said actuator component 90 in response to ejection instructions;
removing the unejected fluid from the one or more actuator components 90 via one or more outlet paths 145 in a respective droplet ejection head 100-900;
transferring thermal energy from said one or more actuator drive electronic components 60 to said heat exchanger 150-950; and
removing some or all of said thermal energy from said heat exchanger 150-950 by:
transferring thermal energy to said unejected fluid in said outlet path 145; and
removing said unejected fluid from said one or more droplet ejection heads 100-900 via said fluid return path 142.

### GENERAL CONSIDERATIONS

As already discussed, a droplet ejection head 100-900, as described herein, may comprise one or more actuator components 90 and an inlet path 144 to supply fluid to the one or more actuator components 90 and an outlet path 145 to remove fluid from the one or more actuator components 90. The one or more actuator components 90 may comprise a plurality of fluid chambers; wherein respective ones of the fluid chambers comprise at least one nozzle; and wherein the fluid chambers are actuable to eject one or more droplets via the at least one nozzle in response to ejection instructions. The plurality of fluid chambers are fluidically connected at a respective first end to the inlet path 144 and are fluidically connected at a respective second end to the outlet path 145. The outlet path 145 may comprises one or more heat exchangers 150-950 arranged serially downstream of the one or more actuator components 90. One or more actuator drive electronic components 60 may be arranged adjacent to each of the heat exchangers 150-950. The one or more heat exchangers 150-950 may comprise one or more fluid paths 151-951, such that in use heat transfers from the actuator drive electronic components 60 to the one or more heat exchangers 150-950 and is removed via the return fluid (where it may be understood that the return fluid is the unejected fluid that leaves the actuator component 90). As already discussed, the area demarcated by the actuator drive electronic components 60 in a plane (for example in the z-x plane) may be substantially contained within the area demarcated by the one or more fluid paths 151-951 within the same plane; these may be referred to as demarcated areas. It may be understood that, where the components such as the heat exchanger and the actuator drive electronic components are physically spaced apart in, for example, the y-direction, then the plane referred to is a common plane (for example z-x plane) onto which the demarcated areas may be projected.

The actuator components 90 described herein may comprise fluid chambers with an actuator associated with each fluid chamber and actuable so as to eject droplets via the one or more nozzles associated with the respective fluid chamber. For example, one or more of the walls of the fluid chambers may be actuable so as to eject fluid droplets via the one or more nozzles. For example, one or more side walls of each fluid chamber may comprise a material showing piezoelectric properties and a suitable drive electrode arrangement, or the fluid chambers may comprise a roof mode actuator arrangement. However, it may be understood that other forms of actuators may also be used, provided that they are suitable to cause the ejection of fluid, via the respective nozzles, from an individual fluid chamber, in response to ejection instructions.

The heat exchanger 150-950, as described herein, may be manufactured using any suitable method, for example, it may be 3D printed, cast, moulded or machined. Further, the heat exchanger 150-950 may comprise one or more parts. It may be understood that, where the heat exchanger comprises two or more parts, then suitable additional components and/or joining methods may be used to ensure fluid-tightness.

It may further be generally understood that the heat exchanger 150-950 may comprise one or more high thermal conductivity materials. For example, the heat exchanger 150-950 may comprise a thermally conductive polymer. Alternatively, the heat exchanger 150-950 may comprise aluminium and/or aluminium alloy 150-950. This may allow the body of the heat exchanger 150-950 to heat to a largely uniform temperature as the heat transfers from the one or more actuator components 60 into the it. This uniformity of temperature in the heat exchanger body means that the heat exchanger fluid path 151-551 may not be limited to the area demarcated by the one or more actuator components 60, instead the fluid path may be optimised to use a larger area by having a heat exchanger 150-950 that is larger, preferably significantly larger, than the area demarcated by the one or more actuator components 60.

It may be understood that the heat exchanger 150-950 may comprise one or more surface treatments and/or coatings on the wetted surfaces of the heat exchanger fluid path 151-951 to protect it from erosion and corrosion and other possible deleterious effects of the return fluid travelling through the heat exchanger fluid path 151-951. Such surface treatments may include methods of altering the structural or chemical behaviour of the bulk material at the surface, for example, surface treatments such as shot-peening and/or anodising. Coatings may comprise one or more layers provided to the wetted surface to provide corrosion protection such as enhanced electrochemical compatibility with the fluid, the coating may further provide electrical insulation between the fluid and the heat exchanger 150-950.

It may be generally understood that a heat exchanger 1050,1150 as described above with a sleeve 1082,1182 and, where present, an interface material 1183 may be manufactured using any suitable method and assembled in any suitable order. For example, as described above, the sleeve 1082,1182 may be formed first with the rest of the heat exchanger 1050,1150 assembled around it. For example, the sleeve 1082,1182 may be formed from a metal tube, such as stainless steel or titanium, shaped by, for example, a tube-forming machine to the intended longitudinal and cross-sectional shape. The heat exchanger 1050,1150 may then be formed and/or assembled around the sleeve, for example by placing the sleeve 1082,1182 as an insert within a mould tool and casting the heat exchanger 1050,1150 around it. Alternatively, the heat exchanger 1050,1150 may be formed first with a void of fluid-path-shape. The sleeve 1082,1182 may then comprise a flexible material, for example a flexible polymer sleeve inserted into the pre-formed path in the heat exchanger 1050,1150 using any suitable method. Alternatively, the heat exchanger 1050,1150 may be formed as two or more parts, for example by machining, casting or machined from extrusion, with a suitable void in each part such that when the parts are joined together, they accommodate the sleeve 1082,1182 and, where present, the interface material 1183 within the heat exchanger 1050,1150. The parts may be manufactured from, for example, metal (aluminium, zinc, or a suitable alloy). Thermal connection between the sleeve 1082,1182 and the heat exchanger 1050,1150 main body might be achieved by one or more of the following: adhesive, paste, mechanical methods (such as hydroforming-internal high-pressure forming, or drawing) or by over-moulding or casting. Still further, it may be generally understood that the sleeve 1082,1182 may have a more complex shape than a simple pipe or tube for example, the sleeve be formed as one or more connected parts to realise complex fluid path structures such as those described herein with respect to other embodiments. Such complex sleeves 1082,1182 may be formed by casting or moulding or 3D printing, for example.

It may be understood that any of the heat exchangers 150-1150 described herein may suitably be used in a droplet ejection apparatus and that any of the heat exchangers 150-1150 may comprise one or more flow control devices in the heat exchanger fluid path 151-1151. The flow control devices may act to increase the internal wetted area of the heat exchanger fluid path 151-1151 and, thereby, improve the thermal transfer from the body of the heat exchanger 150-1150 to the heat exchanger fluid path 151-1151. Still further, the flow control devices may comprise walls and/or surface undulations and/or protruding features (for example, multiple bumps and/or ridges and/or grooves and/or rifling). The heat exchanger fluid path 151-1151 may also weave to-and-fro without any straight sections. The wetted volume of the heat exchanger fluid path 151-1151 may comprise a chamber (rather than a long path), such as that of FIG. 4B, which may have one or more towers projecting from opposing faces (like stalactites and stalagmites in a cave) or it may have continuous columns or pillars 456 stretching across the chamber. The towers on opposing faces may be aligned, or they may be arranged so that the towers on a first face are arranged between the towers on the second opposing face. In general, the heat exchanger fluid path 151-951 may comprise one or more flow control devices, where the flow control devices may comprise one or more walls (peninsula walls 153,553 or island walls 254) and/or ridges 355 and/or pillars 456 and/or columns and/or vanes and or grooves and/or towers. The aim of using such flow control devices may be to maximise contact between the wetted surface area of the heat exchanger fluid path 151-951 and the return fluid, this may need to be balanced against the fluid flow in the fluid path such that the fluid doesn't experience large pressure losses across the heat exchanger 150-950, or experience dead spots of near-stationary or stationary fluid that may cause hot spots in the heat exchanger 150-950.

Where the heat exchanger fluid path 151-951 comprises one or more pipes or tubes, for example a serpentine or meandering path, the bends and any straight sections may be arranged in any orientation. Further, the fluid path 151-951 may comprise one or more return loops. The return loops may be separated by peninsula walls 153,553. For example, the return loops may comprise one or more straight portions, such as legs 551_a-551g in FIG. 5B, arranged parallel to the ejection direction 16, with the respective peninsula walls 553, also parallel to the ejection direction 16. Alternatively, the return loops may comprise one or more straight portions arranged perpendicular to the ejection direction 16, for example legs 151_a, 151_b in FIG. 1C, with the respective peninsula walls 153, also perpendicular to the ejection direction 16. Alternatively, it may be understood that the return loops, and hence the peninsula walls 153,553 may be oriented at any suitable angle, or at one or more angles with respect to the ejection direction 16. Still further, the peninsula walls 153,553, whilst depicted as being largely straight herein, may comprise any suitable shape, for example they may follow a non-linear path, or have a non-linear shape or form (for example, they may have a serpentine or spiralling or meandering shape). In some arrangements the return loops may have substantially the same shape as the outward loops of the fluid path, and/or fit into the gaps between the outward loops, for example, so as to make efficient use of the space available in the heat exchanger 150-1150.

It may generally be understood that the heat exchanger fluid path 151-1151 may comprise two or more sub-paths—for example, as seen in FIG. 2C, it may split into a plurality of sub-paths 251i-251n, where n is any whole number greater than 1, where the sub-paths 251i-251n may comprise any suitable shape of path. The sub-paths may split off at one or more points, similarly the sub-paths may merge downstream at a single point, or groups of two or more sub-paths 251i-251n may merge at different points.

It may generally be understood that the flow control devices depicted and described herein, such as the ridges 355 of FIG. 3A-FIG. 3C and the walls 254 of FIG. 2A-2D and the peninsula walls 153,553 of FIG. 1A-FIG. 1C and FIG. 5A-FIG. 5B, are shown as having straight edges, and being generally rectangular in cross-section, but this is by no means essential and, in other arrangements, there may be flow control devices that have a curved profile, or follow a zig-zag or other non-linear path or may have any another suitable shape. Similarly, the pillars 456 of FIG. 4A are depicted as small rectangles, but they may have any suitable cross-section, for example they may have a circular or vane-shaped or ovoid cross-section. Still further, any of the flow control devices described herein may have suitable rounding of corners and chamfering of edges and blending of the joins between the flow control devices and the walls of the heat exchanger to which they are attached, so as to provide smooth surfaces to the fluid passing through the respective fluid path 151-951. This may be desirable to prevent viscous losses in the fluid path and also to prevent sedimentation, if using pigmented fluids.

It may be generally understood that the fluid paths described herein may comprise flow control devices arranged in the fluid path in one or more planes. For example, the flow control devices may be quasi two-dimensional, i.e., as for the heat exchangers 150-950 depicted in FIG. 1A-FIG. 5B where the flow control devices have a substantially constant profile in the depth direction 5 and are arranged in a pattern or shape in the x-z plane. Alternatively, the structures may have a substantially constant profile in the array direction 10, with the variation in profile, position and shape of the fluid devices being largely in the y-z plane. Still further, in some arrangements, there may be variation in shape and form and position in all three directions; such more complex profiles may be more readily formed using techniques such as 3D printing, for example.

It may generally be understood that, whatever form it takes, whether a serpentine or meandering or spiralling path, with curved and/or straight sections, and/or a path comprising flow control devices as described herein, the route of the fluid path 151-1151 may be chosen to maximise the cooling effect on the actuator drive electronic components 60 by providing the most efficient balance between the length and/or wetted surface area of the fluid path 151-1151 and the proximity of adjacent sections of the serpentine fluid path to each other. This may be within the area demarcated by the electronic components 60 and/or within the area demarcated by the heat exchanger 150-1150. It may be understood that wetted surface area comprises the area of the fluid path 151-1151 in contact with the fluid it carries. It may further be understood that the cooling effect may be balanced against fluidic pressure losses in the fluid path 151-1151 by maximising the fluid path wetted surface area within the heat exchanger 150-1150 whilst minimising the fluidic pressure losses within the heat exchanger.

Minimising the fluidic pressure losses within the heat exchanger 150-1150 may, for example, comprise smoothing corners and junctions using chamfers and the like, it may further comprise avoiding sharp bends and sudden changes in cross-sectional area, for example. It may further be understood that the heat exchanger may have a substantially matched fluid impedance to the fluid inlet path 141. Further, it may be advantageous that the heat exchanger 150-1150 may have a lower fluidic impedance than the actuator component 90 such that the pressure losses in the heat exchanger 150-1150 are lower than the pressure losses in the actuator component 90. In general, the heat exchanger 150-1150 may be designed to minimise its impact on the overall fluid path impedance in the droplet ejection head. Among many factors affecting the fluid path and its impedance, the fluid path may be designed to accommodate a range of recirculating flow ratios (e.g., the proportion of ink ejected through the droplet ejection nozzles in the actuator component 90 vs the proportion exiting it in the return fluid). For example, a worst-case (most demanding) fluid recirculating flow ratio may be ⅓ of the fluid supplied to the actuator component 90 being ejected through the nozzles, vs ⅔ exiting the actuator component 90 in the return fluid. The fluid path may also be designed to cover the full range of possible ejection duties from zero fluid ejection duty (all fluid enters the return path) to 100% fluid ejection duty (i.e., all nozzles ejecting fluid at the same time, note this does not mean 100% of the fluid supplied to the actuator component 90 being ejected through the nozzles).

Whilst the embodiments described herein generally comprise at least two actuator drive electronic components 60i,60ii per heat exchanger 150-1150, one on either side of a respective heat exchanger 150-1150, this is by no means essential and in other arrangements there may be actuator drive electronic components 60 on only one side of the heat exchanger 150-1150. In general, there may be two or more actuator drive electronic components 60 per heat exchanger 150-1150. Still further, each of the actuator drive electronic components 60 may comprise one or more parts or components 60_1-60_n, where n is a whole number, which may be arranged adjacent to each other. It may further be understood that these parts or components may be, individually or as a group, potted or enclosed such that the faces not aligned with the heat exchanger 150-1150 are encapsulated.

It may generally be understood that the actuator drive electronic components 60 may comprise components that are sometimes referred to as ASICs (Application Specific Integrated Circuits). They are one or more electronic components designed to provide drive signals to the actuator component 90 and hence to the actuators in the fluid chambers, so as to drive the fluid chambers to eject droplets of fluid as and when required. It may be generally understood that the ASICs are significant heat generating components on the PCB 70, they are preferably co-located in a sub-area of the PCB 70, i.e., in the area demarcated by the actuator drive electronic components 60, which area may be in a central area of the PCB 70 in the ejection direction 16.

It may further be understood that there may be other electronics components mounted on the PCB 70 at various locations, but that these may be located outside of the area demarcated by the actuator drive electronic components 60, and/or outside the area demarcated by the protrusion heat exchange interface surface(s) 252i,252ii, and/or outside the area demarcated by the first and second thermally conductive regions 70_c1,70_c2, and/or outside the area demarcated by the thermally conductive bonding layer 871i,871ii. It may further be understood that these other electronics components may produce heat at levels that are orders of magnitude less than the heat produced by the actuator drive electronic components 60, such that these other electronics components do not require cooling via thermal connections to the heat exchanger 150-1150.

It may be generally understood that PCB stands for printed circuit board, sometimes just referred to as a circuit board.

It may be understood that, in some arrangements a droplet ejection head may be run in reverse, such that fluid flows through the heat exchanger 150-1150, is heated by heat transferred from the actuator drive electronic components 60 to the heat exchanger 150-1150 and then passes through the actuator component 90. This may be done prior to droplet ejection, for example, to warm the fluid in the actuator component 90 and thereby change the viscosity, or to enable effective priming. Such a method may comprise using a suitable waveform or electronic signals or running a suitable function to cause the actuator drive electronic components 60 to generate heat. Such a method may comprise operating a droplet ejection apparatus 1,2 as described herein, comprising any of the heat exchangers 150-1150 described herein, where the method involves, in turn:
supplying fluid to the one or more droplet ejection apparatus 1,2 via the fluid return path 142;
using a suitable waveform or function to generate heat in the one or more actuator drive electronic components 60;
transferring thermal energy from the one more actuator drive electronic components 60 to the heat exchanger 150-1150;
transferring some or all of the thermal energy from the heat exchanger 150-1150 to the fluid in heat exchanger fluid path 151-1151;
supplying fluid from the heat exchanger 150-1150 to the one or more actuator components 90; and
removing fluid from the one or more actuator components via the inlet path 142.

If the apparatus 1,2 is being run in reverse as part of a droplet ejection process, then the method may further comprise:
ejecting a proportion of the fluid from one or more nozzles in the actuator component 90 in response to ejection instructions prior to removing the un-ejected fluid from the actuator component 90 via the inlet path 140.

It may be generally understood that the diverter 670 and the spigots 660 described herein may be used with any of the heat exchangers described herein and in any of the droplet ejection apparatus described herein. They may be used with suitable flexible tubes to form respective parts of the inlet path 144 and the outlet path 145.

It may generally be understood that the droplet ejection heads 100-900, as described herein, may further comprise a mount and/or a top cover wherein the one or more heat exchangers 150-1150 are thermally insulated from the mount and/or the top cover. For example, the top cover may be arranged to surround and contain the majority of the droplet ejection head internal structure, for example, it may leave some or all of the media facing surface exposed such that the nozzles can be directed towards, and eject droplets towards, a media, such as a printing media such as tiles, or paper, or card, or ceramic, or items such as bottles, containers and other 3D parts.

The mount is to attach the droplet ejection head to a printbar, the printbar may have one or more droplet ejection heads mounted thereto. The mount may be thermally isolated from the heat exchanger 150-1150 using suitable components and materials to provide a thermal barrier. For example, a low conductivity polymer material may be arranged between the mount and the heat exchanger 150-1150. Thermally insulating the mount from the one or more heat exchangers 150-1150 may reduce structural variation in the droplet ejection head 100-900 and improve the alignment to the printbar in the droplet ejection apparatus 1,2 on which the one or more droplet ejection heads 100-900 may be mounted. Further, it may prevent heat being transferred from the droplet ejection head 100-900 to the printbar. This may be desirable because heating the printbar may cause thermal expansion therein, which may affect the alignment between components of the droplet ejection apparatus (such as the alignment between droplet ejection heads when a plurality are mounted on a printbar in a droplet ejection apparatus 1,2).

It may generally be understood that, in a similar manner, the actuator component 90 may be thermally isolated from the heat exchanger 150-1150, by using suitable components and materials to provide a thermal barrier.

There may be one or more inlets and one or more outlets arranged on an external surface of the top cover, for example fluidically connected through, or passing through, the top cover and fluidically connected to the inlet path 144 and the outlet path 145 inside the droplet ejection head 100-900. The one or more inlets and the one or more outlets may be arranged such that, when the droplet ejection head 100-900 is installed in a droplet ejection apparatus 1,2, the fluid inlet path 141 is fluidically connected to the one or more inlets and the fluid return path 142 is fluidically connected to the one or more outlets. The droplet ejection apparatus 1,2 may comprise one or more droplet ejection heads 100-900 as described herein, and a source of droplet ejection fluid 140 fluidically connected to the one or more droplet ejection heads 100-900 via the fluid inlet path 141 so as to supply fluid to the one or more droplet ejection heads 100-900 and a fluid return path 142 to remove fluid from the one or more droplet ejection heads 100-900.

It may generally be understood that features and component parts of a droplet ejection head 100-900 described herein may suitably be combined with features and component parts of any other droplet ejection head 100-900 as described herein and any of the heat exchangers 150-1150 as described herein. It may further be understood that any of the droplet ejection heads 100-900 described herein may be used in a droplet ejection apparatus 1,2 as described herein.

1. A droplet ejection head comprising one or more actuator components and an inlet path to supply fluid to the one or more actuator components and an outlet path to remove fluid from the one or more actuator components;
wherein said one or more actuator components include a plurality of fluid chambers; wherein said fluid chambers include at least one nozzle; and wherein said fluid chambers are actuable to eject one or more droplets via said at least one nozzle in response to ejection instructions;
wherein said plurality of fluid chambers are fluidically connected at a respective first end to said inlet path and are fluidically connected at a respective second end to said outlet path;
wherein said outlet path includes one or more heat exchangers arranged serially downstream of the one or more actuator components;
wherein one or more actuator drive electronic components are arranged adjacent to each of said heat exchangers;
wherein the one or more heat exchangers include one or more heat exchanger fluid paths, such that in use heat transfers from said actuator drive electronic components to said one or more heat exchangers and is removed via the return fluid; and
wherein an area demarcated by the actuator drive electronic components is substantially contained within an area in the same plane demarcated by said one or more heat exchanger fluid paths.

2. The droplet ejection head according to claim 1, wherein the area demarcated by the heat exchanger fluid path is substantially greater than the area demarcated by the actuator drive electronic components.

3. The droplet ejection head according to claim 1, wherein the area of the heat exchanger is substantially greater than the area demarcated by the actuator drive electronic components.

4. The droplet ejection head according to claim 1, wherein said heat exchanger fluid path is a serpentine-shaped fluid path.

5. The droplet ejection head according to claim 1, wherein said heat exchanger fluid path includes two or more sub-paths.

6. The droplet ejection head according to claim 1, wherein said heat exchanger fluid path includes one or more flow control devices;
wherein said flow control devices includes one or more walls and/or ridges and/or pillars and/or columns and/or vanes and/or grooves.

7. (canceled)

8. The droplet ejection head according to claim 1, wherein the route of the heat exchanger fluid path is chosen to maximise the a cooling effect on the actuator drive electronic components by maximising the length and/or the wetted surface area of the heat exchanger fluid path; and/or
wherein the cooling effect is balanced against fluidic pressure losses in the heat exchanger fluid path by maximising the fluid path wetted surface area within the heat exchanger whilst minimising the fluidic pressure losses within the heat exchanger.

9. (canceled)

10. The droplet ejection head according to claim 1, wherein the heat exchanger has a substantially matched fluid impedance to the inlet path.

11. The droplet ejection head according to claim 1, wherein said heat exchanger includes at least one of:
one or more high thermal conductivity materials;
a thermally conductive polymer; or
aluminium or aluminium alloy.

12-16. (canceled)

17. The droplet ejection head according to claim 1, wherein said heat exchanger includes one or more protrusions having heat exchange interface surface(s) aligned with said actuator drive electronic components.

18. The droplet ejection head according to claim 17, wherein said actuator drive electronic components are arranged on one or more PCBs such that said one or more PCBs are interposed between said one or more heat exchange interface surface(s) and said actuator drive electronic components.

19. (canceled)

20. The droplet ejection head according to claim 17, wherein said protrusions provide for an air gap between said PCBs and said heat exchanger except in the region of alignment with said actuator drive electronic components.

21. The droplet ejection head according to of claim 18, wherein each of said one or more PCBs include first and second thermally conductive regions arranged on opposite sides of each of said respective PCBs;
wherein said first and second thermally conductive regions are thermally connected to one another by one or more thermally conductive paths; and
wherein said first thermally conductive region, is aligned with and arranged adjacent to said heat exchange interface surfaces of said one or more protrusions and said second thermally conductive region is aligned with and arranged adjacent to said area demarcated by said actuator drive electronic components.

22-26. (canceled)

27. The droplet ejection head according to claim 1, comprising two or more actuator components and a respective heat exchanger arranged serially downstream of each one of said two or more actuator components.

28. The droplet ejection head according to claim 1, wherein said plurality of fluid chambers are fluidically connected at said first end to one or more first manifold chambers and at said second end to one or more second manifold chambers;
wherein said one or more first manifold chambers are fluidically connected to said inlet path;
wherein said one or more second manifold chambers are fluidically connected to said outlet path; and
wherein said one or more second manifold chambers are fluidically connected in series to a respective one of said one or more heat exchangers.

29. The droplet ejection head according to claim 1, wherein the outlet path includes one or more spigots for connecting to a connecting portion of the outlet path;
wherein each of said spigots and/or said respective connecting portion includes one or more external spherical features; and
wherein each respective external spherical feature is arranged to provide a fluid-tight connection between said spigot and said respective connecting portion of the outlet path.

30. The droplet ejection head according to claim 1, wherein a diverter fluidically connects said inlet path and said outlet path to said actuator component whilst maintaining fluidic separation between said inlet path and said outlet path; and
wherein said diverter includes spherical features to enable fluid-tight connections to said inlet path and said outlet path respectively.

31. The droplet ejection head according to claim 28, wherein a diverter fluidically connects said one or more second manifold chambers to said respective heat exchanger.

32. The droplet ejection head according to claim 29, wherein the droplet ejection head fluid path includes cylindrical features at the inlet and the outlet to receive a portion of said spigots.

33-35. (canceled)

36. A method of cooling one or more actuator drive electronic components for a droplet ejection head comprising one or more actuator components and an inlet path to supply fluid to said one or more actuator components and an outlet path to remove fluid from said one or more actuator components;
wherein said one or more actuator components include a plurality of fluid chambers; wherein said fluid chambers include at least one nozzle; and wherein said fluid chambers are actuable to eject one or more droplets via said at least one nozzle in response to ejection instructions;
wherein said plurality of fluid chambers are fluidically connected at a respective first end to said inlet path and are fluidically connected at a respective second end to said outlet path;
wherein said outlet path includes one or more heat exchangers arranged serially downstream of the one or more actuator components;
wherein one or more actuator drive electronic components are arranged adjacent to each of said heat exchangers;
wherein said one or more heat exchangers include one or more heat exchanger fluid paths, such that in use heat transfers from said actuator drive electronic components to said one or more heat exchangers and is removed via the return fluid; and
wherein the area demarcated by the actuator drive electronic components is substantially contained within the area demarcated by said one or more heat exchanger fluid paths, wherein said method includes, in turn:
supplying fluid to said one or more actuator components via said inlet path; and
removing fluid from said one or more actuator components via said outlet path and introducing fluid into the heat exchanger fluid path such that it flows through the one or more heat exchangers and removes heat transferred to said heat exchanger from said actuator drive electronic components via the fluid flowing through the one or more heat exchangers.

37-38. (canceled)
